(19) United States
(12) Patent Application Publication
(10) Pub. No.: US 2019/0071893 A1
(43) Pub. Date: Mar. 7, 2019

(54) Cylinder Lock with Interact Mobile Devices

(71) Applicant: Bruno Faninger, Coral Gables, FL (US)

(72) Inventor: Bruno Faninger, Coral Gables, FL (US)

(21) Appl. No.: 16/037,643

(22) Filed: Jul. 17, 2018

Related U.S. Application Data
(60) Provisional application No. 62/553,216, filed on Sep. 1, 2017.

(51) Int. Cl. E05B 27/00; E05B 19/00

(52) U.S. Cl. CPC E05B 27/0075; E05B 27/006; E05B 19/0052; E05B 27/001

(57) ABSTRACT

A tumbler pin lock includes one or two auxiliary locking mechanisms including an auxiliary locking pin, and an auxiliary blocking component to provide enhance locking in addition to the locking provided by the tumbler pins so that the lock remains locked even if the tumblers are picked or bumped into their unlocked positions. A cylinder lock is provided with an auxiliary locking pin which projects into the keyway, which, with the proper key, is slid forward with a mobile device into an area in the lock housing where an auxiliary groove allows the cylinder plug to turn. The second locking component, which is approximately rectangular similarly has a post that is moved forward with the insertion of the proper key into an annular groove allowing the cylinder plug to turn.

### RELATED PATENT APPLICATIONS

62/553,216—Provisional patent application Filing date Jul. 17, 2017

### BACKGROUND

### Prior Art Patents

U.S. Patents

| Patent number | Kind Code | Issue Date | Patentee |
|---|---|---|---|
| U.S. Pat. No. 4,723,427 | A | 1986 Mar. 21 | Roy N. Oliver |
| U.S. Pat. No. 5,819,566 | A | 1991 Jan. 29 | Charles W. Eden |
| | | | Jr. |
| U.S. Pat. No. 5,823,030 | A | 1997-01029 | Kenneth Theriault |
| U.S. Pat. No. 6,526,791 | A | 2001 Feb. 26 | Vladimir Shvarts |
| U.S. Pat. No. 6,959,570 | B2 | 2005 Nov. 1 | Dennis Price |
| U.S. Pat. No. 12,413,139 | B2 | 2012 May 29 | Peter H. Field |

### Field of the Invention

The present invention pertains to a high security cylinder lock that prevents the use of well knowing systems to open the cylinders of the locks, only to mention the most knowing as lock picking and bumping. This invention is an improvement to current cylinders locks in the market, and more specifically, this invention is used to increase the security in the cylinders used in locks fitted in doors, padlocks and any device where the security device to open a lock is based on the cylinder lock fitted in the lock.

### Background of the Invention Field

Current cylinders have limited security in opening locks of houses, padlocks and similar security devices. Just to name only few of ways of non-authorized entry, there are lock picking, bumping, bumping with elastic device, all of which have been proven to be very effective in opening in a very short time the cylinders. These methods operate with particular picking tools that put the plug of the cylinder in tension and then proceed, once the plug is in tension, to lift the pins until a certain height in order that the line of separation between the adjacent pins is in the area of division between the body of the cylinder and the plug rotatable of the cylinder. In this way, when all the pins have been lifted in the abovementioned area, the plug can rotate and consequently open the lock. In the actual cylinder lock, there is a necessity to not allow non-authorized persons to put the internal plug in tension in order to allow the plug to move and consequently open the lock

### Description of Prior Art Patents

U.S. Pat. No. 4,723,427 has a side bar which is symmetrical with regard to a radius through a center of the key plug perpendicular to the plane of the key so that the side bar intersects not only slots in the twisting tumblers, but the profile of the key. U.S. Pat. No. 4,723,427 does not have a sliding device

U.S. Pat. No. 5,819,566 is a cylinder lock is provided with a resiliently biased auxiliary locking pin which projects into the keyway and then retracts the locking pin into the shell. The device of U.S. Pat. No. 5,819,566 does not have a sliding component

U.S. Pat. No. 5,823,030 discloses a key having profile features which include a shaped indentation on a first side of the blade and an aligned projection on the opposite side of the blade cooperates with a cylinder lock with unauthorized key trapping capability.

U.S. Pat. No. 6,526,791 uses a flexible coupling connected between the locking pin and the sensor pin, the coupling moving the locking pin to the unlocked position when the sensor pin moves to the retracted position to provide additional security.

U.S. Pat. No. 6,959,570 design employs multiple arrays of pass key pins to make picking the lock more difficult but doesn't utilizing sliding components.

U.S. Ser. No. 12/413,139 is a tumbler pin lock that includes an auxiliary locking mechanism including an auxiliary locking pin to provide enhance locking in addition to the tumbler pins. Part of the claim states “an auxiliary locking pin disposed within said cylindrical plug and moveable between a first position in which a portion of said auxiliary locking pin extends out of a hole formed in an outer wall of said cylindrical plug and a second position in which said auxiliary locking pin is retracted into said hole.”

This patent is closest to the invention presented in that it has, in addition to the pin and tumbler system, a locking pin that needs to be moved in order for the lock to open. U.S. patent Ser. No. 12/413,139 retracts the pin, while the invention disclosed in this application moves the sliding mechanism (mobile device) forward so that a projection on the mobile device an turn in a groove when the key is turned. The second embodiment of the invention disclosed in this application adds a second somewhat square blocking device which also needs to be moved to turn in a groove, for triple protection which U.S. Ser. No. 12/413,139 does not have.

### SUMMARY OF THE INVENTION

This invention first embodiment takes a standard type pin and tumbler cylinder lock and adds new features: sliding mobile devices, which holds the pins rather than the plug, which are small mostly rectangular blocks, with interior slots on the inside of the mobile devices to accept the key. A small projection on each mobile device having a small projection in a predetermined position; blocking posts that protrudes from the shell to stop the mobile device from turning more than a small distance, and an annular groove in an inner housing shell which allows the mobile device' projection to rotate when the proper key is inserted. The key first aligns with the pins to create a shear line. Then the key pushes the mobile device forward and pin and projection line up with the annular grooves which allows the plug to turn. This is a second defense, the first being the pin and tumbler system, against picking as the mobile devices can only go forward, and not turn, blocked by posts, in the case of attempted unauthorized entry through picking or other means.

This invention second embodiment adds a third line of defense against unauthorized entry through picking or other means. A second blocking (152 in FIG. 14) component is added into the back end grove, which has a small post that travels in a groove (156 in FIG. 18, which is not present in the first embodiment) of the mobile device. The second blocking component is held in place by an elastic piece or spring which is positioned against a pin. The key has a notch on the very end designed to interact with the blocking component which pushes the blocking component to the rear where it aligns with rear annular grooves (the front annular grooves are in the front of the housing) that allow the plug to turn.

### DETAILED DESCRIPTION OF THE INVENTION

### Brief Description of the Features Number in the Drawings

1. key
2. inner housing shell
3. housing shell
4. rotatable plug when lock is opened
5. mobile devices
13. area of the key that contacts the surface of the blocking pin
14. key blades
16. teeth on key
22. block pins in the shell
24. mounting hole in inner lock housing sleeve
25. holes in the inner housing for blocking pins
26. longitudinal groove in the inner housing shell
27. annular groove in the inner housing shell
31. mounting posts inner housing shell to the housing shell
32. covers for the holes where the tumbling pins and spring are located
33. holes in the housing for mounting posts
34. holes in the housing for springs and pins
36. mounting hole for connecting posts
37. connecting posts
41. keyway in plug
42. key face on plug
43. elastic element, spring type device
44. hole for the spring that provides bias for the mobile device upon entry of the key
45. longitudinal groove along the outside of the plug
46. annular groove of plug
47. inside surface of lock housing sleeve that holds the plug
48. interior surface of the plug
51. pins within plug when opened
52. tumbler segments
53. tumbler springs
56. projection on mobile devices to prevent turning
57. holes in mobile devices to hold pins
58. groove in the mobile devices for key insertion.
61. retainer washer
62. Spring clip

The following items are for the second embodiment from FIG. 14
100. Key
101. key blade
102. key teeth
104. key blade
105. surface of the key that contact the surface of the first interior pin
106. area of the key that engages the surface of the second blocking component
130. housing shell
131. mounting hole in the lock housing shell
132. cover plug for the mounting hole
133. locking pins for the annular grooves
134. annular grooves in the internal shell allowing blocking post on the second mobile to turn
135. right annular grooves in the internal shell allowing mobile device projection to turn
136. retainer clip
137. recesses for mobile devices
138. radial mounting hole for connecting post
139. connecting post
140. plug
141. keyway
142. key face on plug
145. longitudinal groove along the outside of the plug
146. pins in the grooves to prevent tuning when proper key is not inserted
147. elastic elements spring type device
148. hole for the spring that provides bias for the mobile device upon entry of the key
149. annular groove of the plug
150. second mobile device
151. projection on mobile devices to prevent turning
152. second blocking component
153. post on second locking element that turns in groove
154. elastic elements, spring or similar to hold
155. guide post
156. guide in the second mobile device
157. holes in the second mobile device
158. pin holding the spring that holds in the second blocking component
159. rear surface of plug

### BRIEF DESCRIPTION OF THE DRAWINGS

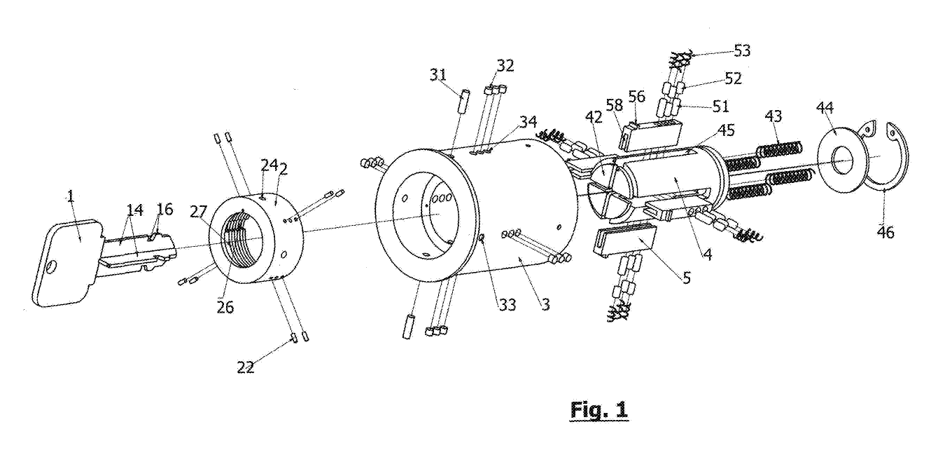

FIG. 1 shows an exploded view of the parts composing the cylinder in accordance with the first preferred embodiment of the present invention.

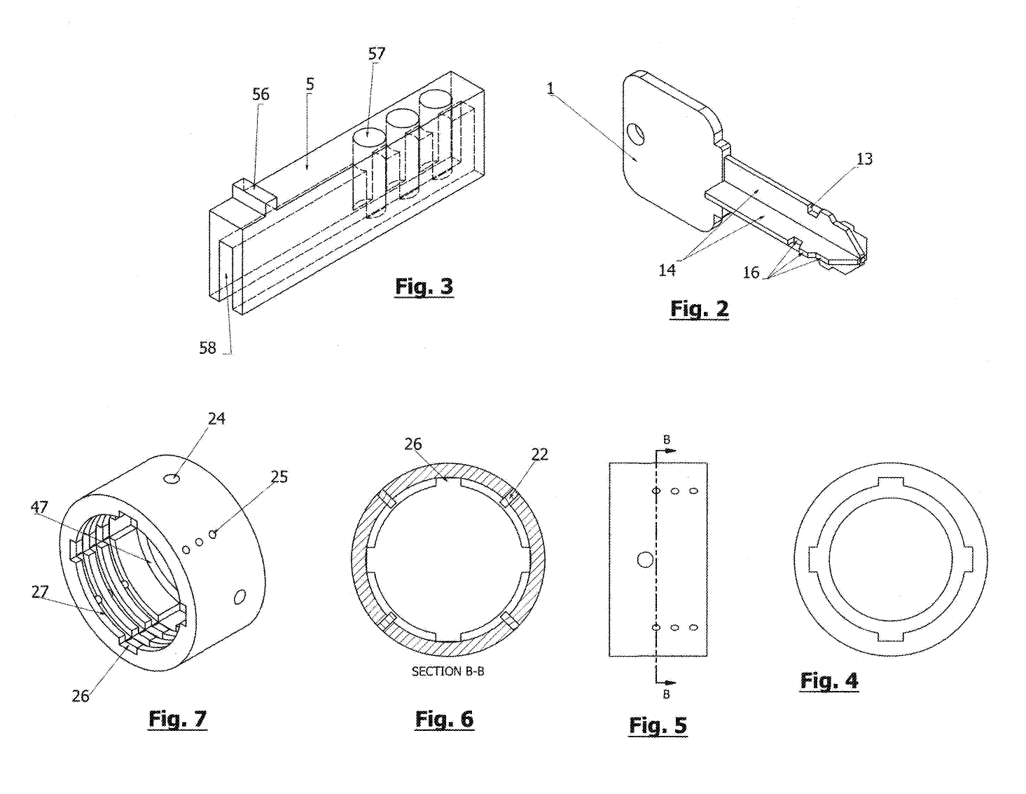

FIG. 2 is a perspective view of the key of the present invention.

FIG. 3 is a perspective view of the mobile device sliding longitudinal in the plug.

FIG. 4 is a frontal view of the element fixed solidary to the front part of the shell FIG. 5 is a lateral view of the inner housing in FIG. 4.

FIG. 5 is a top view of the mobile device showing the location of the pins.

FIG. 6 is a cross-sectional view along line B-B of the element in FIG. 5.

FIG. 7 is a perspective view of the inner housing shell of FIG. 4.

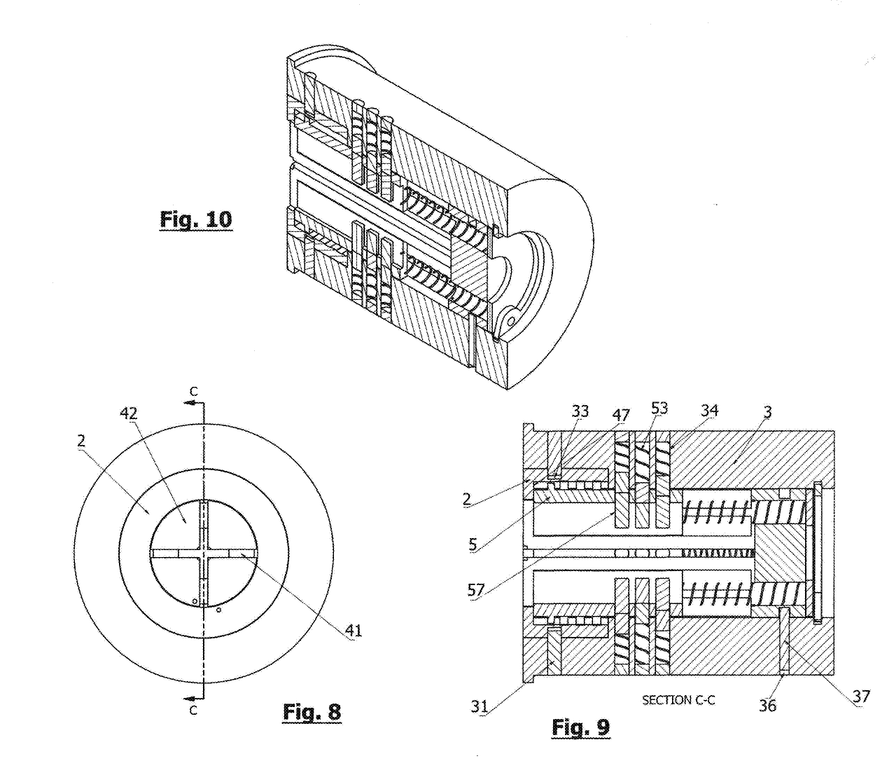

FIG. 8 is a frontal view of the cylinder in accordance with the first preferred embodiment of the present invention.

FIG. 9 is a longitudinal view along line C-C of the FIG. 8 illustrating the cylinder in a locking position.

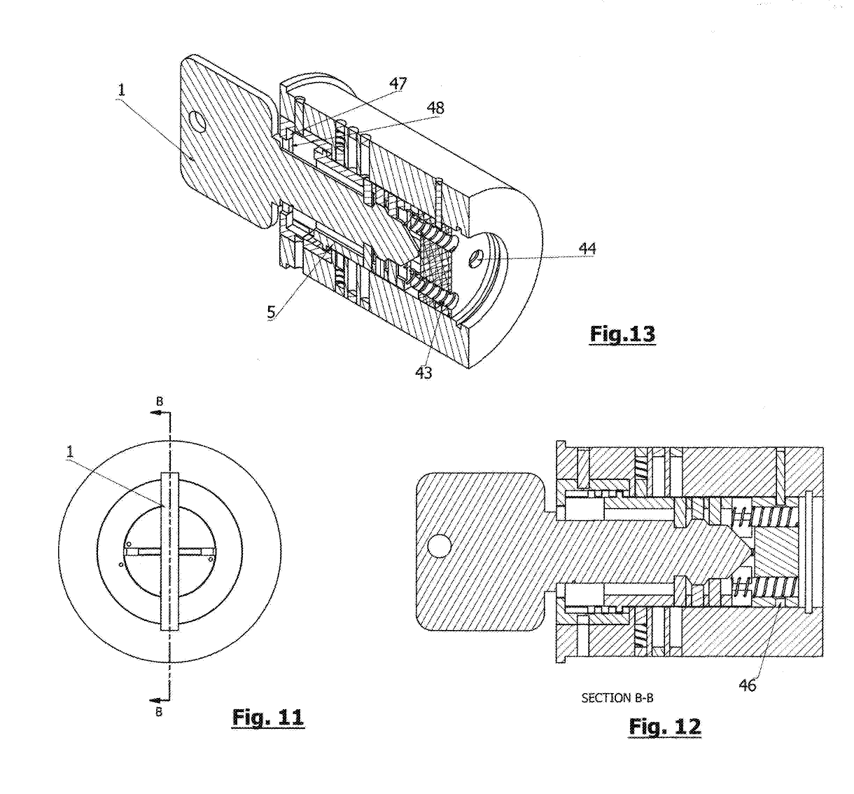

FIG. 10 is a perspective view of the FIG. 9.

FIG. 11 is a frontal view of the cylinder with the key totally inserted in the keyway and in unlocked state.

FIG. 12 is a longitudinal view along line B-B of the FIG. 11 illustrating the cylinder with the key totally inserted in the keyway and in unlocked state and without the rear cover and the retaining ring.

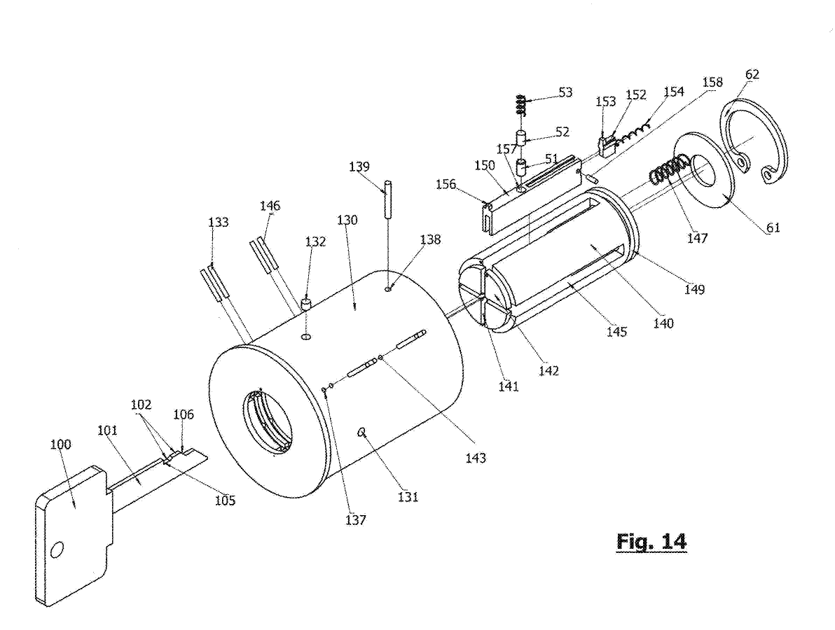

FIG. 13 is a perspective view of the FIG. 12

FIG. 14 shows an exploded view of the parts composing the cylinder in accordance with the second preferred embodiment of the present invention.

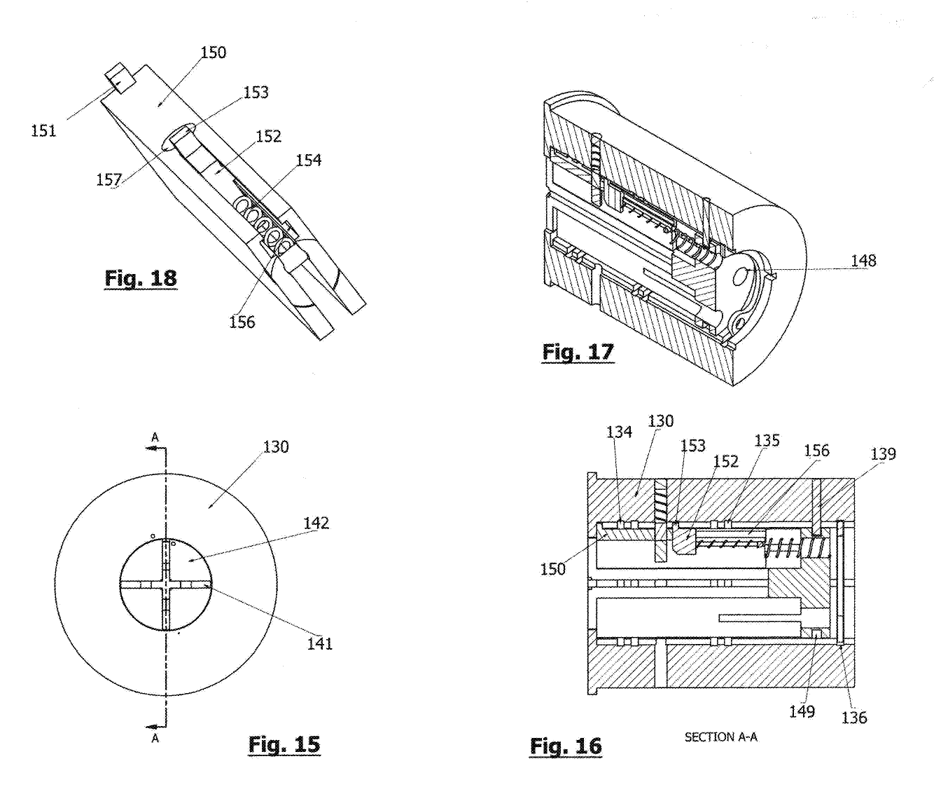

FIG. 15 is a frontal view of the cylinder in accordance with the second preferred embodiment of the present invention.

FIG. 16 is a longitudinal view along line A-A of the FIG. 15 illustrating the cylinder in a locking position.

FIG. 17 is a perspective view of the FIG. 16.

FIG. 18 is a perspective view of the main mobile device in the second preferred embodiment.

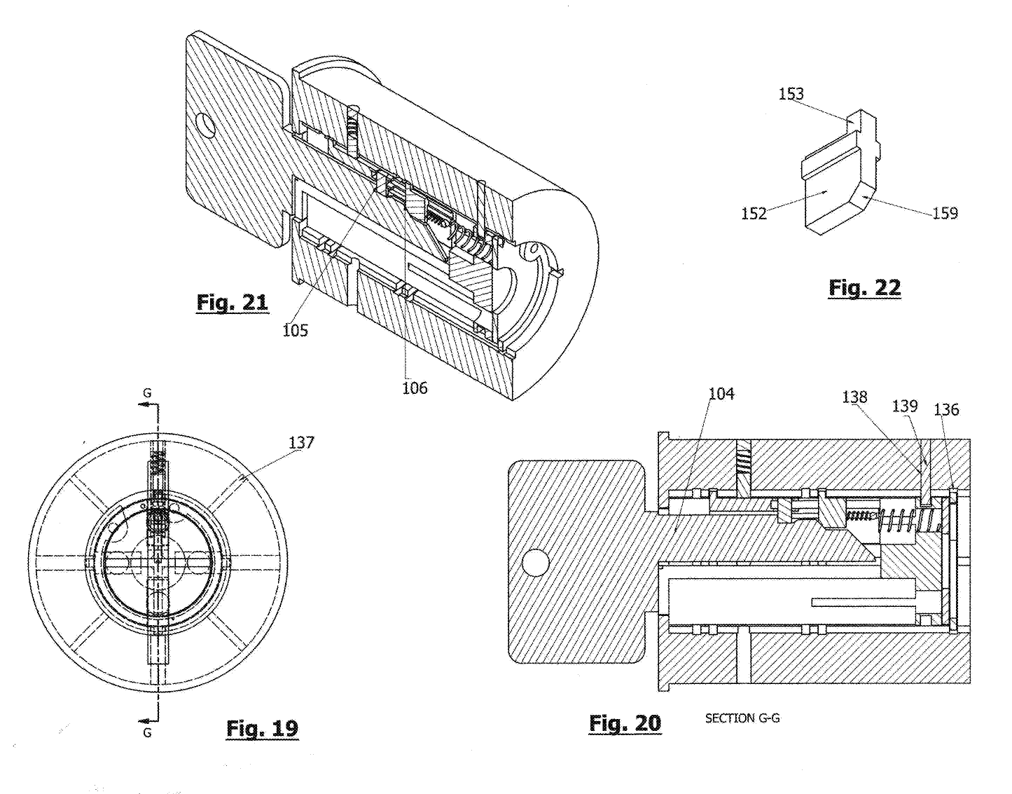

FIG. 19 is a frontal view of the cylinder with the key totally inserted in the keyway and in unlocked state.

FIG. 20 is a longitudinal view along line G-G of the FIG. 19 illustrating the cylinder with the key totally inserted in the keyway and in unlocked state.

FIG. 21 is a perspective view of the FIG. 20

FIG. 22 is a perspective view of the secondary mobile component

### BRIEF DESCRIPTION OF EMBODIMENTS

### Preferred Embodiment

The solution offered in this application has the pins that normally were moving up and down in the plug, moving up and down in a mobile device that slides in the plug, and these pins, separate at the shear line when the correct key is used. The mobile device has a projection on top that contacts blocking pins (in the grooves where the projection will slide) from the housing to minimize turning without the proper key inserted, when the mobile device slides forward after the correct key is inserted, the pins are at a shear line, and the projection can rotate in the groove in the inner housing shell that doesn't have blocking pins allowing the plug to rotate.

### Second Embodiment

Has the elements of the first embodiment, but adds a second mobile device component near the back of the plug (away from the key entering point) which blocks the plug turning unless it is moved axial to the back of the plug where a post on the second mobile device component enters a groove which will enable rotation.

### DETAILED DESCRIPTION

The preferred embodiment is operable by a single key. In FIG. 1, where this solution is illustrated with all the elements unassembled, it is illustrated a cylinder lock with two types of locking mechanism coexistent and engaged between them, where the first one, formed by the pins, 51 and 52, and a spring 53, like the one used in current cylinders and where the pins slide internally in a hole 57 in the mobile device 5. The second locking mechanism concerns the projection 56 on the mobile device 5. Internally in the inner shell 2, there are several annular grooves 27 with blocks 22, except one groove without a block, the grooves with blocks function is to block the projection 56 on the upper edge of the mobile device 5 from rotating far enough to allow the lock to open and therefore block the plug 4 from continuing to rotate. When the mobile device 5 is pushed forward the proper distance by the key 1, it turns in the groove without the blocking pins and the plug will turn and the lock will open.

For the sake of brevity in description, in this embodiment the number of mobile devices 5 was limited to four, and said pins, tumbler pins and springs are not described in detail, since they are fully conventional in terms of shape and operation. The cylinder that is object of this idea is composed of several basic components: The shell 3 that is the outer casing where inside of it there is a plug 4, rotatable in the shell, and where the shell is provided with several holes 34 where the spring 53 and the pins 51 and 52 move. The plug 4 has a keyway 41, the slot where the key goes in, and is provided with holes 44 FIG. 13) where are located elastic elements or plug springs 43, and which act in the same plane longitudinal that cuts the groove 45 in the middle, biasing the mobile devices 5 toward the internal surface 47 (FIG. 7) of the inner housing shell 2 and the surface 48 (FIG. 13) of the plug that are in the same orthogonal plane. The elastic element or spring 43 is kept in the plug hole 44 by a retaining washer 61 which one is kept against the plug by a spring clip 62 that in this embodiment is an internal retaining ring. The mobile devices 5, are mounted so they can slide within cooperating longitudinal grooves 45 in the plug 4 and therefore these mobile devices can move only in the direction of the axle of the plug 4 and therefore impeding the plug to rotate until a properly configured key is inserted.

Present in the upper part there are one or more holes 57 (FIG. 3) where are sliding the devices 51 and 52 and in the edge closes to the middle of the plug a groove 58 where can be introduced the key 1 and said groove passes through the holes 57 (FIG. 3). The axis of the holes 57 in the mobile device 5 are correspondent to the axis of the holes 34 in the shell in the locking position. The mobile devices 5 have in the upper edge a projected part 56 locate in a predetermined position for each mobile device 5. Referring to FIG. 9, the radial tumbler holes, 34 and 57, of the shell 3 and mobile device 5 respectively, are aligned when the preferred embodiment is in the locked position. The tumbler springs 53 urge the tumbler segments 51 and 52, towards the center of the plug 4, so that the tumbler segments 52 are disposed between the junction of the housing shell 3 and the mobile devices 5 and consequently the mobile devices 5 are not allowed to translate Assuming that the properly configured key 1 has been inserted into the preferred embodiment, the junctions of the tumblers segments, 51 and 52, coincide with the junction of the shell and the mobile device 5 is permitted to translate.

Referring to FIGS. 1, 9 and 10, mounting posts 31 extend from the radial through holes 33 and through the radial mounting holes 24, to secure the inner shell 2 to the outer shell 3. Internally in the inner shell 2, there are several annular grooves 27 with blocks 22, except one groove without a block, the grooves with blocks function is to block the projection from rotating far enough to allow the lock to open and therefore block the plug 4 from continuing to rotate. Plugs 32 are the covers for the holes 34 where the pins 51, 52 and spring 53 are located. The inner housing shell 2 has a number of longitudinal grooves 26 that are in contact with the external walls of the part 56 of mobile devices 5, with all but one groove with blocking pins 22 the blocking pins are in the grooves 27 with the blocked grooves not allowing, in the locked position, rotation movement of said mobile devices 5.

The key 1 is provided with several blades 14 and each of them could present different shapes and is operatively adapted to be inserted through an opening or keyway 41 in the front face 42 of the plug 4 and through the inferior groove 58 of device 5. The blades of the key are provided with teeth 16 in the front part of the key blades 14. A connecting post 37 extends from the radial mounting hole 36 of the shell 1 into the annular groove 46 of the plug 4 to rotatably secure the plug 4 to the shell 3. The way in which the key works is the following: when inserting the key 1 in the keyway 41 and proceeding until the end, the various profiles 16 of the first part of the key 1 enter into the grooves 58 of mobile devices 5 and pushes the pairs of pins 51 and 52 up, so that the top pins no longer are located in mobile device 5 and the bottom of them are up at the interior edge of the housing shell creating a shear line between the plug and the shell. Contemporary when all the pins 51 and 52 have been up in the right position, the surface 13 of key 1 gets in contact with the surface of the first interior pin that it encounters (counting from the keyway). In this configuration the mobile devices 5 are free to slide longitudinally in the plug grooves 45.

Continuing to proceed with the key the area 13 of the key gets in contact with the surface of the blocking pin 51, the key 1 will move the pin longitudinally in the groove 45, and consequently the mobile device 5 in which the pin is fitted, until a position in which the corresponding annular grooves 27 will allow the part 56 to pass in said groove. This activity causes the tumblers segments, 51 and 52, to separate and the tumbler 51 engage the key 1 with the mobile device 5, thereby preventing uprooting of the key 1. If the projected part 56 in the mobile device 5 enter in the right annular groove 27 (groove without the block 22), the plug would be allowed to rotate completely and open the cylinder. If the part 56 enter in a groove with the block 22, the plug would be allowed to rotate for some degrees and then will be obstructed by the block 22, and consequently the plug will not rotate leaving the lock locked. The key in this embodiment has four blades 14 and four mobile devices 5 but the number of blades 14 could be more depending on the number of longitudinal groves 45 fitted in the plug. The mobile devices 5 could have one or more holes 57 and the mobile devices 5 could be one or more in each groove 45. The configuration of the projection on the mobile device 56 is presented flat but could be curved or any shape depending of the design. This kinematic of the mobile devices, not allowing to put the plug in a circular tension, is obliging the non-authorized person that is willing to open the cylinder without the relative correspondent key, to proceed in a way much more complicate with respect of the actual cylinders, increasing in this way the security offered by this type of cylinder lock. This means that the operation should be made with multiple picks with in the lock so the probability of picking the lock becomes minuscule because it will be practically unmanageable to manipulate more pick tools at once. Such a cylinder lock would further be adaptable to a variety of lock doors, padlocks and similar actual in the market, and would be made with a minimal number of internal parts, in the most convenient material, each of which are relatively easy to produce to reduce cost. The preferred embodiment thus offers two locking sections operable by a single key. The drawings do not show the (conventional rotatable) mechanism regarding the bolt connected to the cylinder. These details of construction have not been illustrated since, they can be made in any known way, and they do not fail within the scope of the invention.

In a second preferred embodiment that is illustrated with all the elements unassembled in FIG. 14, where this solution for simplicity of drawing and understanding, has been illustrated with only one mobile device 150 sliding in one groove 145 and where the key 100 has only one blade 101 that interact with the single second mobile device 150. (Note: the second mobile device of the second embodiment includes an opening for the second locking component 152 (FIG. 18 and FIG. 22), which is not in the mobile device 5). Most of the elements of the first embodiment don't vary except the second mobile device 150 sliding in the plug 4 (140 in the second embodiment) and the housing shell 130 in the second embodiment which had additional grooves to accommodate the turning of the second locking component 152.

The inner housing shell 2 has been eliminated in this embodiment with the annular grooves now in the shell 3. FIG. 16 and FIG. 18 illustrate the second mobile device 150 in which there is a second blocking component 152 that slides in the guide 156 internally in the second mobile device 150, and this element is pressed by elastic elements 154 that is biasing the device 152 to return to the initial position in the second mobile device 150, that is the locking position. The device 150 has a pin 158 against which (is pressed) the element 154. The second mobile device 150 can be provided with one or more holes 157 and in this illustration is provided with a single hole 157 in which the pins 51 and 52 are inserted. The shell 130 has internally grooves 134 and 135 and where internally is rotatable the plug 140. A connecting post 139 extends from the radial mounting hole 138 of the shell 1 into the annular groove 149 of the plug 140 so as to rotatably secure the plug 140 to the shell 130. In the grooves 135 there are also the blocking pins 146 the holes are the blocking pin are 143.

The way in which the key works in this embodiment is as follows: inserting the key 100 in the keyway 141 and proceeding, the area 106 of the key gets engaged with the surface 159 of the second locking component 152 and start to move it in the direction of the rear part of the cylinder meanwhile the teeth 102 in the blade 101 start to up the pins 51 and 52 until all the bottom of the superior pins is out of the hole in the plug and contemporary the surface 105 of the key gets in contact with the surface of the first interior pin (counting from the front). In this situation, and proceeding the key entering, the device 150 starts to move until a predefined position where the post 153 of the second mobile device 152 is placed in front of the right annular groove 135 (FIG. 16) and the post in the second mobile device 156 in front of the right annular groove 134. Contemporary all the blades of the key proceed with the same procedure. At this point the plug is in an unlocked position and free to rotate to open the cylinder. The second preferred embodiment thus offers three locking sections operable by a single key 100.

1. A lock comprising:
a cylindrical plug having an axially-extending key way adapted to receive a conforming key;
a mobile device that slides axially that hold a plurality of tumbler pins disposed within radially-oriented tumbler pin holes formed in said mobile and adapted to control rotation of said cylindrical plug, wherein said tumbler pins are constructed and arranged to be engaged by the conforming key inserted into said keyway and to be positioned by the key within their respective tumbler pin holes to create a shear line between the plug and a lock housing shell;
the mobile device having a projection on top;
the lock housing shell having locking pins located that project into all but one annular grooves in which the projection of the mobile device turns;
Whereby the mobile device in disposed within said cylindrical plug recesses and moveable in an axial direction between a first position and a second position, said mobile being constructed and arranged to be engaged by the conforming key inserted into the keyway to move said mobile device from the first position into the second position, wherein said second position of the mobile device aligns the tumbler pins to create a shear and aligns the projection of the mobile device into a annular groove without blocking pins, allowing the plug to turn.

2. The lock according to claim 1, wherein said mobile device is disposed within a recess formed in said cylindrical plug adjacent said keyway and includes a contact surface projecting into said keyway so as to be engaged by a key inserted into said keyway.

3. The lock according to claim 1, where two or more mobile devices are utilized, and where the key has a number of blades that are equal to recesses in the cylindrical plug.

4. The lock of claim 1 with multiple sets of locking pins at different location within each annular groove.

5. The lock according to claim 1, further comprising elastic elements that acts in a longitudinal plane to biasing the mobile devices toward the internal surface of the keyway.

6. A lock system comprising the lock according to claim 1 and a key configured to be inserted into said keyway to position said tumbler pins to engage said mobile device to move from its first position to its second position so as to permit said cylindrical plug to rotate.

7. A lock system comprising the lock according to claim 1 and a key configured to be inserted into said keyway to position said tumbler pins to create a shear line and to move the projection on the mobile device into a groove without blocking pins to permit said cylindrical plug to rotate and unlock.

8. A lock comprising:
a cylindrical plug having an axially-extending keyway adapted to receive a conforming key;
a second mobile device that slides axially that hold a plurality of tumbler pins disposed within radially-oriented tumbler pin holes formed in said mobile device and adapted to block rotation of said cylindrical plug, wherein said tumbler pins are constructed and arranged to be engaged by the conforming key inserted into said keyway and to be positioned by the key within their respective tumbler pin holes to create a shear line between the plug and a lock housing shell;
the second mobile device having a projection on top;
the second mobile device having a second blocking component with a post that sits further back from the keyway;
whereby inserting the key in the keyway and proceeding, the area of the key gets engaged with the rear surface of the second mobile element and start to move it in the direction of the rear part of the cylinder to the second position where the second mobile elements post aligns with a groove in the inner shell housing, concurrently the teeth in the blade line up the tumbler pins until they create a shear line, and, the second mobile device moves into a predefined position where the post of the projection on the second mobile device is placed in a right annular groove without blocking pins, at which time the plug is in an unlocked position and free to rotate to open the cylinder.

9. The lock according to claim 8, wherein said mobile device is disposed within a recess formed in said cylindrical plug adjacent said keyway and includes a contact surface projecting into said keyway so as to be engaged by a key inserted into said keyway.

10. The lock according to claim 8, where two or more mobile devices are utilized, and where the key has a number blades that are equal to the recesses in the cylindrical plug.

11. The lock of claim 8 with multiple sets of locking pins at different locations within each annular groove.

12. The lock according to claim 8, further comprising elastic elements that acts in a longitudinal plane to biasing the mobile devices toward the internal surface of the lock housing shell.

13. A lock system comprising the lock according to claim 8 and a key configured to be inserted into said keyway to position said tumbler pins so as to permit said cylindrical plug to rotate and to engage said mobile device to move said mobile device from its first position to its second position.

12. The lock system of claim 8, wherein said mobile device is disposed within a recess formed in said cylindrical plug adjacent said keyway and includes a contact surface projecting into said keyway and said key includes a key blade and a contact surface formed on said key blade for engaging the second mobile device.
